(19) United States
(12) Patent Application Publication
(10) Pub. No.: US 2007/0196563 A1
(43) Pub. Date: Aug. 23, 2007

(54) Three-dimensional pvd targets, and methods of forming three-dimensional pvd targets

(76) Inventors: Yi Wuwen, Veradale, WA (US); Susan D. Strothers, Spokane, WA (US); Diana L. Morales, Veradale, WA (US); Rodger W. Lycan, Orchards, WA (US); Ira Nolander, Spokane, WA (US)

Correspondence Address: WELLS ST. JOHN P.S., 601 WEST FIRST AVE, SUITE 1300, SPOKANE, WA, 99201, US

(21) Appl. No.: 11/664,358

(22) PCT Filed: Nov. 15, 2005
(86) PCT No.: PCT/US05/41255

§ 371 Date: Mar. 29, 2007

Related U.S. Application Data
(60) Provisional application No. 60/629,532, filed on Nov. 18, 2004.

(51) Int. Cl. B05D 5/12

(52) U.S. Cl. 427/74

(57) ABSTRACT

The invention includes methods by which hot isostatic pressing is utilized to form physical vapor deposition targets. In particular aspects, the physical vapor deposition targets can contain one or more of iridium, cobalt, ruthenium, tungsten, molybdenum, titanium, aluminum and tantalum; and/or one or more of aluminides, silicides, carbides and chalcogenides. The invention also includes three-dimensional targets which include one or more of iridium, cobalt, ruthenium, tungsten molybdenum, titanium, aluminum and tantalum.

### TECHNICAL FIELD

The invention pertains to methods of forming three-dimensional physical vapor deposition (PVD) targets, such as, for example, hollow cathode magnetron targets.

### BACKGROUND OF THE INVENTION

Physical vapor deposition (PVD) is a commonly used method for forming thin layers of material in semiconductor fabrication processes. PVD includes sputtering processes. In an exemplary PVD process, a cathodic target is exposed to a beam of high-intensity particles. As the high-intensity particles impact a surface of the target, they force materials to be ejected from the target surface. The materials can then settle on a semiconductor substrate to form a thin film of the materials across the substrate.

Difficulties are encountered during PVD processes in attempting to obtain a uniform film thickness across the various undulating features that can be associated with a semiconductor substrate surface. Attempts have been made to address such difficulties with target geometry. Accordingly, numerous target geometries are currently being commercially produced. Exemplary geometries are described with reference to FIGS. 1-12. FIGS. 1 and 2 illustrate an isometric view and cross-sectional side view, respectively, of an Applied Materials Self Ionized Plasma Plus™ target construction 10. FIGS. 3 and 4 illustrate an isometric view and cross-sectional side view, respectively, of a Novellus Hollow Cathode Magnetron™ target construction 12. FIGS. 5 and 6 illustrate an isometric and cross-sectional side view, respectively, of a Applied Materials Endura™ target construction 14. FIGS. 7 and 8 illustrate an isometric and cross-sectional side view, respectively, of a flat target construction 16. FIGS. 9 and 10 illustrate a top view and cross-sectional side view, respectively, of a Tokyo Electron Limited (TEL) target construction 18. FIGS. 11 and 12 illustrate a top view and cross-sectional side view, respectively, of an ULVAC target construction 20.

Each of the cross-sectional side views of FIGS. 2, 4, 6, 8 10 and 12 is shown comprising horizontal dimensions “X” and vertical dimensions “Y”. The ratio of “Y” to “X” can determine if the target is a so-called three-dimensional target, or a two-dimensional target. Specifically, each of the targets comprises a horizontal dimension “X” of from about 15 inches to about 21 inches. The Applied Materials™ target (FIG. 2) will typically comprise a vertical dimension “Y” of about five inches, the Novellus™ target (FIG. 4) will typically comprise a vertical dimension of about 10 inches, the Endura™ target (FIG. 6) will typically comprise a vertical dimension of from about two inches to about six inches, and the flat target will typically comprise a vertical dimension of less than or equal to about 1 inch. For purposes of interpreting this disclosure and the claims that follow, a target is considered to be a three-dimensional target if the target has a more complicated shape than the simple planar target of FIG. 8, and in some aspects a three-dimensional target can be a target in which the ratio of the vertical dimension “Y” to the horizontal dimension “X” is greater than or equal to 0.15. In particular aspects of the present invention, a three-dimensional target can have a ratio of the vertical dimension “Y” to the horizontal dimension “X” of greater than or equal to 0.5. If the ratio of the vertical dimension “Y” to the horizontal dimension “X” is less than 0.15, the target is considered a two-dimensional target.

The Applied Materials™ target (FIG. 2) and Novellus™ target (FIG. 4) can be considered to comprise complex three-dimensional geometries, in that it is difficult to fabricate monolithic targets having the geometries of such targets.

The Applied Materials™ target (FIG. 2) and Novellus™ target (FIG. 4) both share the geometrical characteristic of comprising a at least one cup 11 having a pair of opposing ends 13 and 15. End 15 is open and end 13 is closed. The cups 11 have hollows 19 extending therein. Further, each cup 11 has an internal (or interior) surface 21 defining a periphery of the hollow 19, and an exterior surface 23 in opposing relation to the interior surface. The exterior surface 23 extends around each cup 11, and wraps around the closed ends 13 at corners 25. Targets 10 and 12 each have a sidewall 27 defined by the exterior surface and extending between the ends 13 and 15. The targets of 10 and 12 of FIGS. 2 and 4 further share the characteristic of a flange 29 extending around the sidewall 27. A difference between the target 12 of FIG. 4 relative to the target 10 of FIG. 2 is that target 10 has a cavity 17 extending downwardly through a center of the target to narrow the cup 11 of target 10 relative to the cup of target 12.

There can be numerous advantages for utilizing three-dimensional targets in physical vapor deposition processes, as opposed to two-dimensional, or planar, targets. Such advantages can include uniformity in quantity and/or quality of deposited material. However, there are numerous materials which are difficult to form into three-dimensional targets. For instance, it can be difficult to form materials comprising, consisting essentially of, or consisting of one or more of the relatively brittle materials ruthenium, tungsten and molybdenum into three-dimensional targets. Yet, there is a desire for having such materials available for sputter deposition processes. For instance, ruthenium can have uses in the semiconductor industry for incorporation into barrier materials. Accordingly, it would be desirable to develop new methods of forming three-dimensional targets which were applicable for utilization with relatively brittle materials. There are also materials which, although not particularly brittle, are difficult to form into three-dimensional targets with conventional technologies. It would be further desirable for the new methods to be applicable for numerous materials difficult to form into three-dimensional targets with conventional technologies.

### SUMMARY OF THE INVENTION

In one aspect, the invention encompasses a method of forming a hollow cathode magnetron target. A can is formed to be substantially complementary to a desired hollow cathode magnetron target shape. Powdered material is placed within the can, with the powdered material comprising one or more of iridium, cobalt, ruthenium, tungsten, molybdenum, titanium, aluminum and tantalum; and/or one or more materials selected from the group consisting of silicides, aluminides, carbides and chalcogenides. One or more of the iridium, cobalt, ruthenium, tungsten, molybdenum, titanium, aluminum and tantalum can, in some aspects of the invention, be in alloy form. The canned powder is subjected to hot isostatic pressing to form the material into a physical vapor deposition target substantially having the desired hollow cathode magnetron target shape. In subsequent processing, some or all of the can is removed.

In one aspect, the invention encompasses a method of forming a three-dimensional physical vapor deposition target from material which is difficult or impossible to extrude into a three-dimensional shape. A can is formed which is substantially complementary to the desired three-dimensional shape of the target. Powdered material is placed within the can, and the canned powdered material is subjected to hot isostatic pressing to form the material into a physical vapor deposition target substantially having the desired three-dimensional shape. At least a portion of the can is removed from the physical vapor deposition target. In some aspects, an entirety of the can is removed from the physical vapor deposition target, and in other aspects only a portion of the can is removed from the physical vapor deposition target, with a remaining portion of the can being incorporated as a backing plate attached to the physical vapor deposition target.

In aspects in which a portion of the can remains attached to the physical vapor deposition target as a backing plate, flanges can be attached to such portion of the can. The flanges can be attached as part of the can before the hot isostatic pressing or can be attached after the hot isostatic pressing. In particular aspects, the flanges can be attached with a weld prior to the hot isostatic pressing, the weld can be evacuated, and then the hot isostatic pressing can be utilized to enhance bonding between the flange and the portion of the can that will ultimately be utilized as a backing plate for the three-dimensional target.

### BRIEF DESCRIPTION OF THE DRAWINGS

Preferred embodiments of the invention are described below with reference to the following accompanying drawings.

FIG. 1 is an isometric view of a prior art Applied Materials™ sputtering target.

FIG. 2 is a cross-sectional side view of the sputtering target of FIG. 1.

FIG. 3 is an isometric view of a prior art Novellus™ hollow cathode sputtering target.

FIG. 4 is a cross-sectional side view of the FIG. 3 sputtering target.

FIG. 5 is an isometric view of a prior art Applied Materials Endura™ sputtering target.

FIG. 6 is a cross-sectional side view of the FIG. 5 sputtering target.

FIG. 7 is an isometric view of a prior art flat sputtering target.

FIG. 8 is a cross-sectional side view of the FIG. 7 sputtering target.

FIG. 9 is an top view of a prior art sputtering target.

FIG. 10 is a cross-sectional side view of the FIG. 9 sputtering target.

FIG. 11 is an top view of a prior art sputtering target.

FIG. 12 is a cross-sectional side view of the FIG. 11 sputtering target.

FIG. 13 is a diagrammatic, cross-sectional view of an exemplary can at a preliminary processing stage of an exemplary method of the present invention.

FIG. 14 is a view of the FIG. 13 can shown at a processing stage subsequent to that of FIG. 13, and having powdered target material provided therein.

FIG. 15 is a view of the FIG. 13 can shown a processing stage subsequent to that of FIG. 14 after the powdered target material has been consolidated into a target construction.

FIG. 16 is a view of the FIG. 15 target construction after removal of the can.

FIG. 17 is a view of the FIG. 15 target construction shown at a processing stage subsequent to that of FIG. 15 in accordance with an alternative embodiment relative to that of FIG. 16.

FIG. 18 is a view of the FIG. 17 construction shown at a processing stage subsequent to that of FIG. 17.

FIG. 19 is a diagrammatic, cross-sectional view of an exemplary can formed in accordance with another embodiment of the invention, and having powdered target material provided therein.

FIG. 20 is a view of the FIG. 19 construction shown at a processing stage subsequent to that of FIG. 19.

FIG. 21 is view of the FIG. 19 construction shown at a processing stage subsequent to that of FIG. 20, and specifically shown after the powdered target material has been consolidated into a target construction.

FIG. 22 is a view of the FIG. 21 construction shown at a processing stage shown subsequent to that of FIG. 21, and specifically after removal of some of the can to leave a target/backing plate construction.

FIG. 23 is a view of the FIG. 22 construction shown at a processing stage subsequent to that of FIG. 22 to form an exemplary final target/backing plate construction.

FIG. 24 is view of a construction analogous to that of FIG. 21 illustrating another aspect of the present invention.

FIG. 25 is a view of the FIG. 24 construction shown at a processing stage shown subsequent to that of FIG. 24, and specifically after removal of some of the can to leave a target/backing plate construction.

FIG. 26 is a view of the FIG. 25 construction shown at a processing stage subsequent to that of FIG. 25 to form an exemplary final target/backing plate construction.

FIG. 27 is a diagrammatic, cross-sectional view of an exemplary can formed in accordance with another aspect of the present invention.

FIG. 28 is a diagrammatic, cross-sectional view of a can formed in accordance with another aspect of the invention.

FIG. 29 is a diagrammatic, cross-sectional view of an exemplary target/backing plate construction formed utilizing the can of FIG. 28.

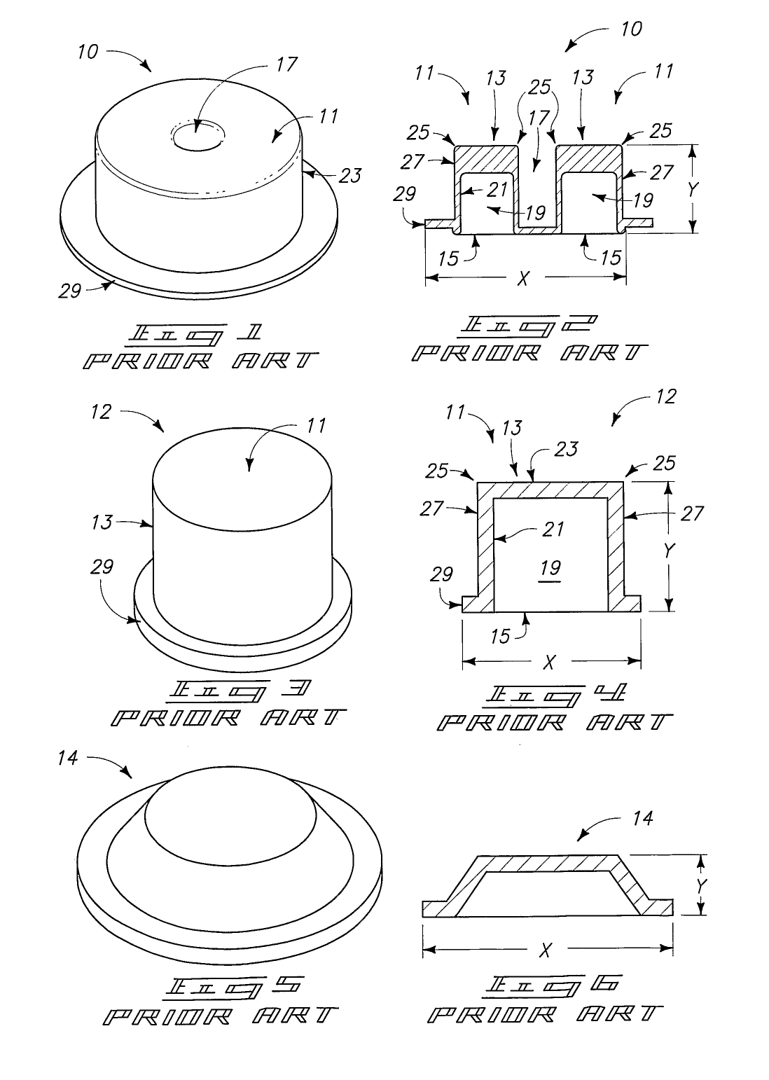

### DETAILED DESCRIPTION OF THE PREFERRED EMBODIMENTS

Ruthenium and tungsten targets have previously been made into planar-shaped targets utilizing hot press techniques and hot isostatic press (HIP) techniques. The ruthenium is considered a desired barrier material for future generation semiconductor chips (45 nanometers and beyond), and tungsten is also considered to have applications for incorporation into semiconductor chips. Accordingly, the industry has been looking for three-dimensional target configurations (such as, for example, hollow cathode magnetron (HCM) configuration targets) comprising, consisting essentially of, or consisting of ruthenium or tungsten. However, the brittleness of ruthenium and tungsten makes it non-feasible to form three-dimensional targets from such materials in traditional methods such as deep-drawing and die-forging. The present invention provides a new process for forming three-dimensional targets. The methodology of the present invention can be utilized for forming three-dimensional targets of any of numerous materials including, for example, materials comprising, consisting essentially of, or consisting of one or more of iridium, cobalt, ruthenium, tungsten, molybdenum, titanium, aluminum and tantalum.

In exemplary aspects of the invention, three-dimensional targets are formed by hot isostatic pressing (HIPping) utilizing consolidation of appropriate composition powders within cans substantially approximating desired shapes of the three-dimensional targets.

An exemplary can which can be utilized in exemplary aspects of the invention is shown in FIG. 13 as a can 100. The can is shown to be non-assembled at the processing stage of FIG. 13, and accordingly is shown to comprise a first cup 102, and a second cup 104 configured to fit within the first cup. First cup 102 comprises a first composition. Such composition can be any suitable composition, and can, for example, comprise aluminum, copper, steel, titanium, composite materials, etc. In particular aspects, cup 102 will comprise, consist essentially of, or consist of aluminum, copper or titanium, or comprise, consist essentially of, or consist of alloys of aluminum, copper and/or titanium. Cup 104 can have the same composition as cup 102 in some aspects of the invention, or can have a different composition in other aspects.

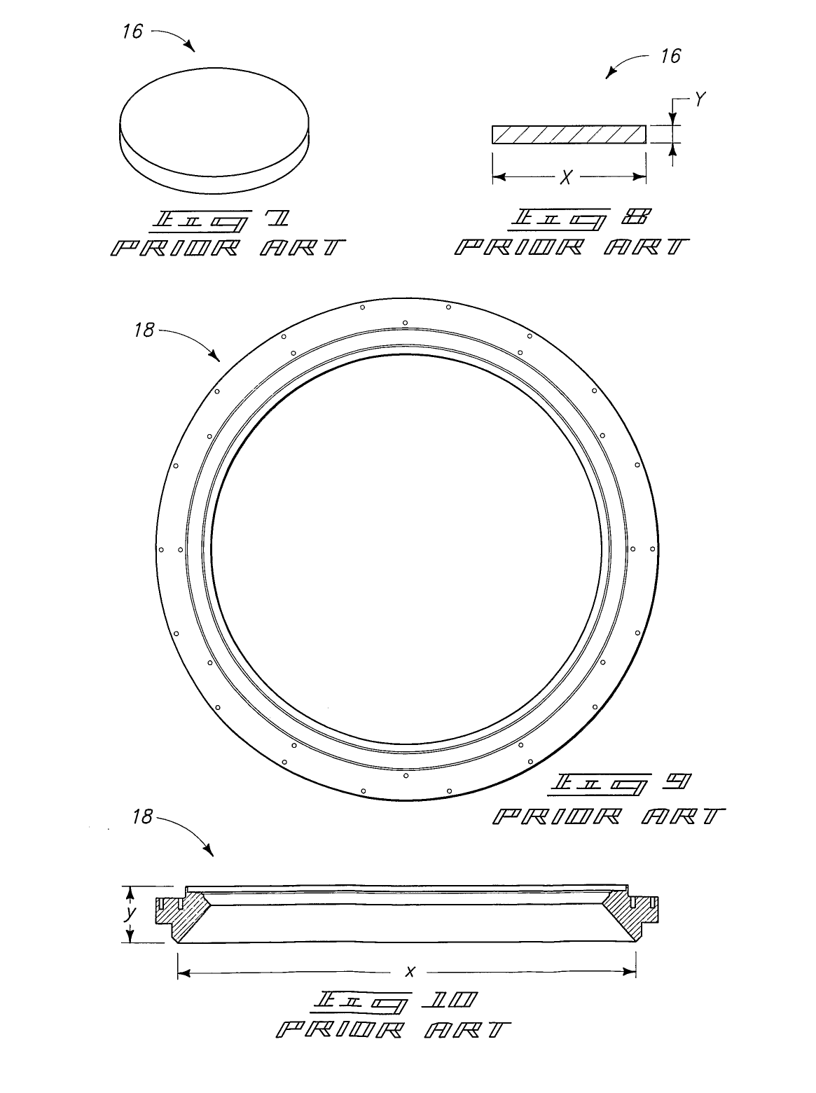

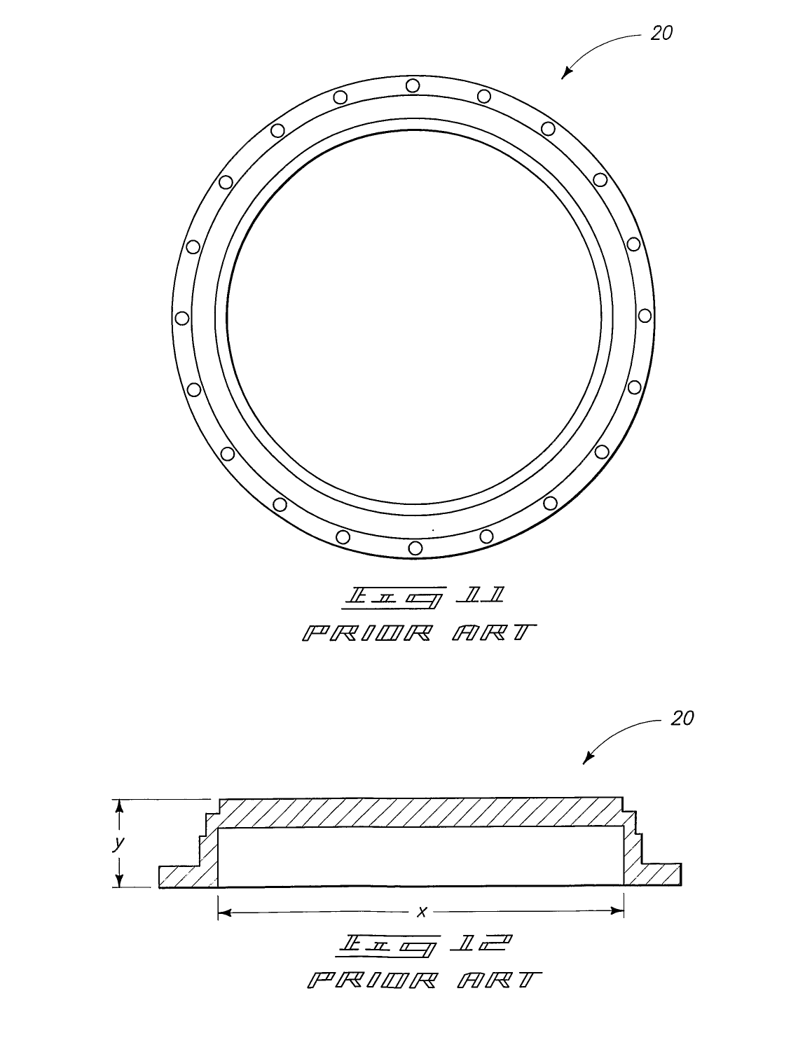

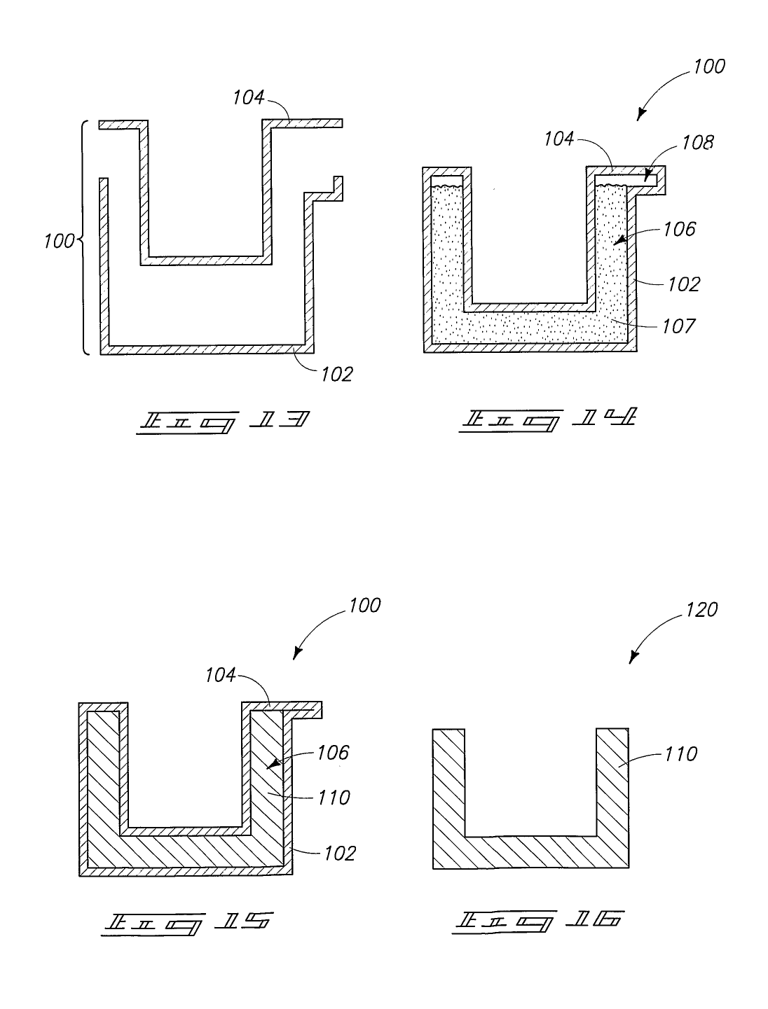

Referring next to FIG. 14, cup 104 is joined to cup 102 (such joining can be accomplished by, for example, welding) to assemble the can 100. The assembled can has a void 106 therein. Powder 107 of a desired target composition is provided within the void 106. Void 106 is approximately the desired shape of a three-dimensional target, and accordingly can 100 can be considered to be substantially complementary to a desired three-dimensional shape of a target. In the shown aspect of the invention, can 100 is substantially complementary to the shape of an HCM target, such as, for example, the target described with reference to FIGS. 3 and 4 above. It is to be understood, however, that the invention encompasses other embodiments (not shown) in which the can is formed to be substantially complementary to other three-dimensional target configurations.

The powdered target material can comprise any desired composition, and in particular aspects will comprise, consist essentially of, or consist of one or more of iridium, cobalt, ruthenium, tungsten, molybdenum, titanium, aluminum and tantalum; which can include any suitable alloys of iridium, cobalt, ruthenium, tungsten, molybdenum, titanium, aluminum and/or tantalum. In some aspects, the powdered target material can comprise aluminides, silicides, chalcogenides, and/or carbides. In particular aspects in which it is desired to form a target of high purity ruthenium, tungsten or molybdenum, the powdered material can consist essentially of, or consist of ruthenium, tungsten or molybdenum. For instance, the powdered material can comprise at least 99.9 weight % or higher purity of ruthenium, tungsten or molybdenum.

Void 106 is shown extending into a nipple region 108 from which the void can be connected to a vacuum and substantially evacuated of gas. After such evacuation, a seal is formed across the nipple region (such seal can be formed by, for example, welding) to retain the evacuated condition within void 106 and throughout the powder that had been provided within void 106. Although the nipple region is shown only along one side of the can, it is to be understood that the nipple region can extend entirely around the can so that the cross-section of FIG. 14 is symmetric about a center axis. Also, although only one nipple region is shown it is to be understood that multiple nipple regions can be utilized. Also, although the nipple region is shown extending laterally outward of a side of the can, it is to be understood that the nipple can extend in other directions, such as, for example, downwardly or upwardly.

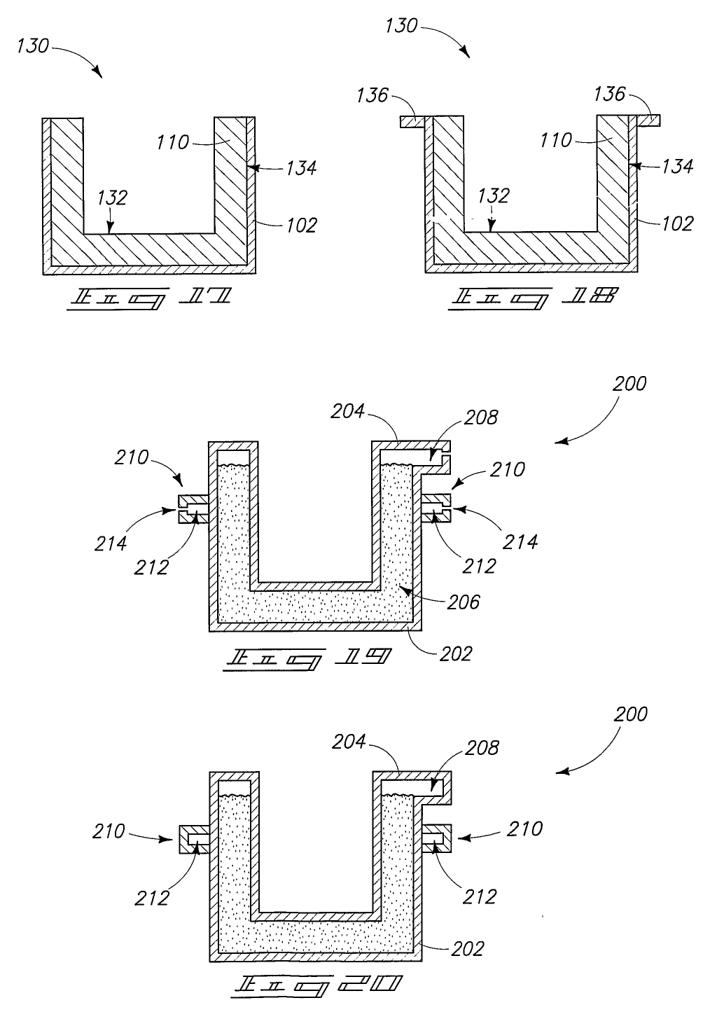

Referring to FIG. 15, can 100 is illustrated after it has been subjected to a hot isostatic pressing (HIPping) process to consolidate the powder (FIG. 14) into a solid 110. Such solid corresponds to a physical vapor deposition target construction having a shape which is substantially the desired three-dimensional shape of a PVD target. The shape is referred to as being substantially the desired three-dimensional shape to indicate that the shape may require minor machining to achieve the actual desired three-dimensional shape. Although the powder is shown to not extend into nipple region 104, it is to be understood that the powder could, in some aspects extend into the nipple region. In such aspects, the nipple region can be formed to extend entirely around the can so that the consolidated powder within the nipple region forms a flange extending entirely around the solid 110.

The can 100 is shown collapsed onto solid 110 at the processing stage of FIG. 15. Collapse of the can would typically occur during a HIPping process, but in some aspects, not shown, some space can remain within the can after the consolidation of the powder into solid 110.

The HIPping utilized to form structure 110 can comprise any suitable conditions. In exemplary processes, the HIPping is utilized to consolidate powders consisting essentially of, or consisting of one or more of ruthenium, tungsten and molybdenum, and in such exemplary processes the HIPping can utilize isostatic pressure of about 30,000 pounds per square inch (psi) in combination with a temperature of about 1500° C. The pressure and temperature can, however, be any suitable conditions, and accordingly the temperature can also be less than 1500° C. in some aspects and greater than 1500° C. in other aspects; and the pressure can be less than 30,000 psi in some aspects and greater than 30,000 psi in other aspects.

The composition of the can is preferably a material which can withstand the high temperatures of the HIPping process without melting, and accordingly it can be desired to utilize titanium for the can.

After the HIPping process, the can 100 (FIG. 15) can be removed from solid 110 to leave a monolithic target consisting of the solid 110. FIG. 16 shows a monolithic target 120 consisting of the solid 110. In other aspects, only a portion of the can is removed to leave another portion of the can remaining bonded to the target to form a target/backing plate construction. Such is illustrated in FIG. 17, where a target/backing plate construction 130 is shown to comprise the solid 110 bonded to a portion of cup 102. The target/backing plate construction 130 comprises a sputtering surface 132 within the interior of the target, and comprises an interface 134 between an exterior of the target and the cup 102, with cup 102 being bonded to target 110 through such interface. The bonding can be a diffusion bond generated during the HIPping process.

The removal of the entirety of the can or a portion thereof can be accomplished utilizing any appropriate machining and/or chemical treatment.

The targets 120 and 130 of FIGS. 16 and 17 are similar to the target construction 12 of FIGS. 3 and 4, except that the targets of FIGS. 16 and 17 lack the flange 29. Such flange is ultimately utilized for retaining the targets in a sputtering apparatus, and accordingly it is desired to provide such flange on the target constructions. The flange can be formed of target material, and made as part of a monolithic target construction during a HIPping process so that the target construction 120 of FIG. 16 can comprise the flanges as-formed in various aspects of the invention (not shown). However, for targets comprising brittle materials, such as, for example, ruthenium, such can be problematic in that the flanges would then also comprise the brittle material and be likely to break when subjected to forces within a sputtering apparatus or during insertion of the target into the sputtering apparatus. Further, the target materials are frequently expensive, and accordingly it would be more cost effective to form the flanges of a relatively cheap material than of the expensive target materials.

The cup 102 of the FIG. 17 construction can be utilized for retaining a flange, as shown in FIG. 18. Specifically, FIG. 18 shows the construction 130 of FIG. 17 after a flange 136 has been attached to cup 102. The flange can be attached by e-beam welding, and/or any other suitable attachment means. Flange 136 can comprise the same composition as can 102, or can comprise other compositions.

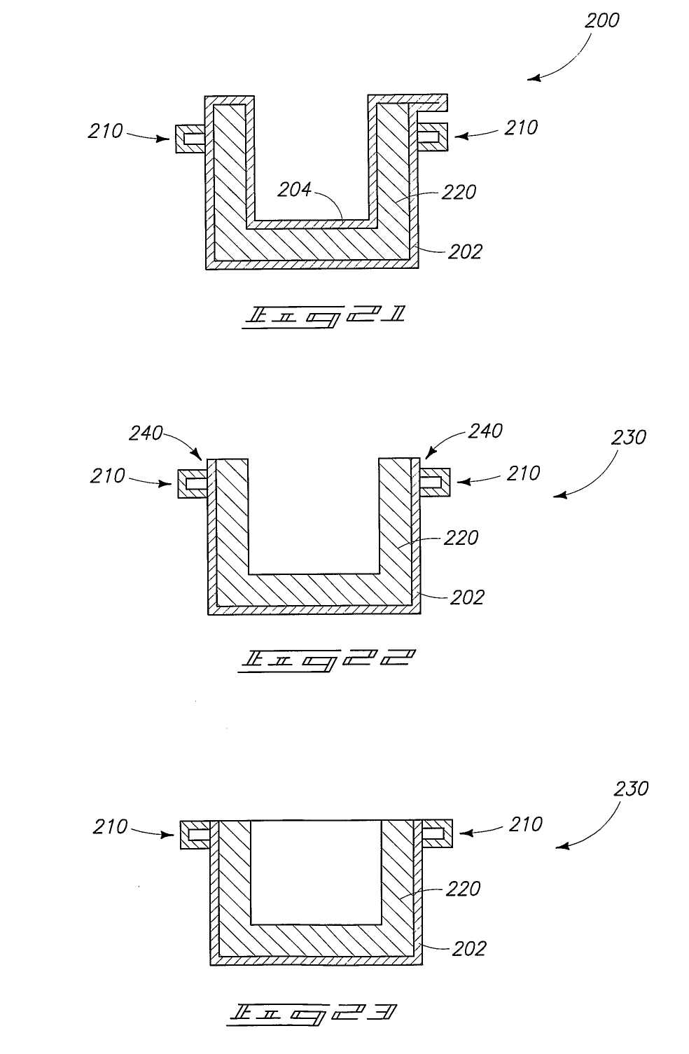

Although the flange 136 of FIG. 18 is described as being attached after the HIPping process, it is to be understood the invention encompasses other embodiments in which the flange is attached prior to the HIPping process. FIGS. 19-23 illustrate an exemplary aspect in which a flange is attached prior to a HIPping process.

Referring initially to FIG. 19, a can construction 200 is shown at a preliminary processing stage. The can construction comprises an inner cup 204, and an outer cup 202 joined with the inner cup. The can construction comprises a void 206 between the inner and outer cups, and comprises a nipple region 208 which can be utilized for evacuating gasses from within the void region. The can construction also comprises a flange 210 attached to outer cup 202. Although the flange 210 appears to be two separate flanges in the cross-sectional view of FIG. 19, it is to be understood that the construction 200 of FIG. 19 would typically be round when viewed from above, and that the flange 210 would typically be a single flange extending entirely around such round construction.

The shown flange is hollow, and accordingly comprises an interior region 212. The flange is shown having an inlet 214 extending therethrough which can be utilized for evacuating the flange prior to a HIPping process. The flange can be attached to cup 202 by a weld, such as, for example, a Tig (i.e., tungsten inert gas) weld, or any other suitable bond. Although the flange is shown to be hollow so that the weld can be evacuated, it is to be understood that the invention encompasses other aspects in which the flange is solid (an exemplary embodiment of such aspect is described below with reference to FIGS. 24-26). Also, although the flange is shown as being a separate piece from cup 202, it is to be understood that the invention encompasses other aspects in which the flange and cup 202 are part of a one-piece construction (an exemplary embodiment of this aspect is also described below with reference to FIGS. 24-26).

FIG. 20 shows the construction 200 at a processing stage subsequent to that of FIG. 19, and specifically shows nipple region 208 sealed after evacuation of gas from within void 206, and also shows inlets 214 of flange 210 sealed after evacuation of gas from within interior region 212 of the flange. The void 206 and voids 212 can be considered to be substantially entirely evacuated to indicate that the voids are evacuated to a desired state, rather than being entirely evacuated of gas.

Referring to FIG. 21, construction 200 is shown at a processing stage subsequent to that of FIG. 20, and specifically is shown after the construction has been subjected to a HIPping process to consolidate the powder and form a target construction 220 from such powder. The HIPping process can also enhance bonding of flange 210 to can 206. The HIPping has collapsed the can onto the target.

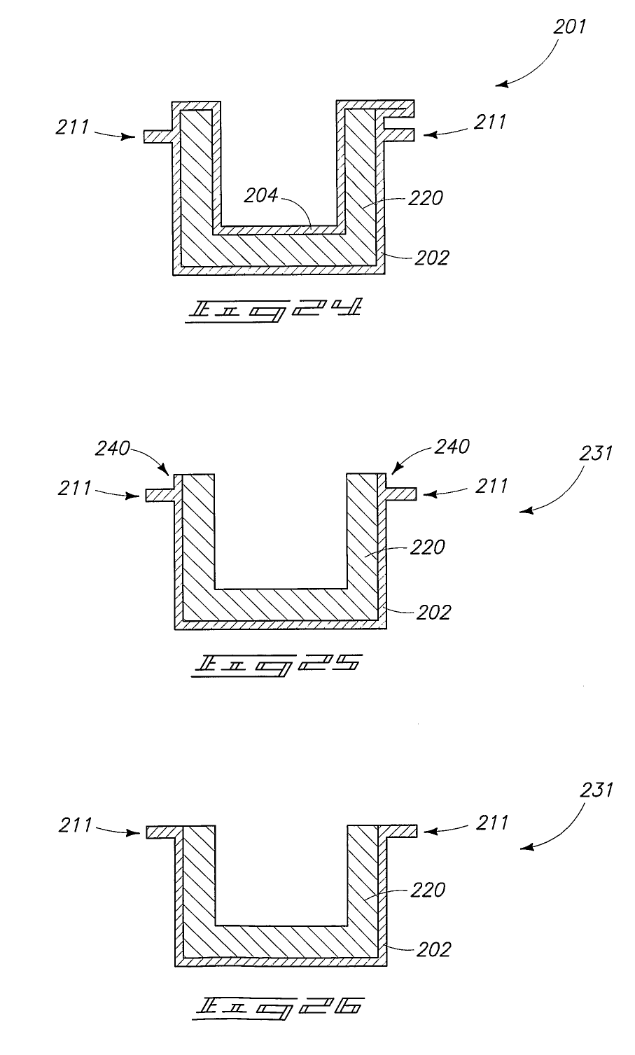

Referring next to FIG. 22, the inner cup 204 (FIG. 21) of the can is removed, while the outer cup 202 (or at least a portion of the outer cup) remains to form a target/backing plate construction 230. Also, the flange 210 remains attached to the remaining portion of outer cup 202 in the target/backing plate construction 230.

In the shown processing stage of FIG. 22, the target and backing plate have a region 240 which extends above the flange 210. Such can be a final construction of the target/backing plate construction. Alternatively, subsequent machining can be conducted to remove material of target 220 and cup 202 so that the uppermost surfaces of materials 202 and 220 are substantially co-planar with an uppermost surface of flange 210. FIG. 23 shows target/backing plate 230 after such removal. It is to be noted that the term “uppermost surface” is utilized in referring to FIGS. 22 and 23 to designate a surface which is uppermost in the shown views, and not to imply that a particular surface would be uppermost in any application of the target/backing plate construction. In fact, the target/backing plate construction will typically be upside-down relative to the shown views of FIGS. 22 and 23 in sputtering applications, so that the uppermost surface of FIGS. 22 and 23 would actually be a lower-most surface in applications of the construction.

Although the flanges 210 of the embodiment of FIGS. 19-23 are shown to be hollow and of a different material than the can 202, it is to be understood that the flanges could also be solid throughout, and of the same material as can 202. Such aspect of the invention is shown in FIGS. 24-26, which are analogous to FIGS. 21-23, but show constructions 201 and 231 having solid flanges 211 that are one piece with can 202.

The targets formed in accordance with the methodology of the present invention (for example, the target 110 of FIGS. 16,17 and 18, and the target 220 of FIGS. 22, 23, 25 and 26), can comprise any of numerous compositions. In particular aspects, the targets will comprise, consist essentially of, or consist of one or more of iridium, cobalt, ruthenium, tungsten, molybdenum, titanium, aluminum and tantalum; and/or will comprise a composition selected from the group consisting of aluminides, silicides, carbides and chalcogenides. In specific aspects, the targets can comprise, consist essentially of, or consist of mixed materials, such as, for example, mixtures of tungsten and titanium (i.e., tungsten/titanium), mixtures of tungsten and aluminum (i.e., tungsten/aluminum), or mixtures of tantalum and aluminum (i.e., tantalum/aluminum). Targets can be high purity in desired compositions, and can, for example, comprise 99.9 weight % or higher of a desired composition. In particular aspects, the targets can comprise 99.99 weight % or higher of one or more of iridium, cobalt, ruthenium, tungsten, molybdenum, titanium, aluminum and tantalum; including aspects in which the target is substantially pure ruthenium, tungsten or molybdenum; as well as aspects in which the targets are mixtures, or alloys, of materials including, mixtures of tungsten and titanium, mixtures of tungsten and aluminum, and mixtures of tantalum and aluminum. Further, the targets can have high density (in some aspects, the density of the composition within a target can be greater than or equal to 98% of the theoretical maximum density of the target composition). Additionally, if the target composition is crystalline, the composition can have relatively small grain sizes within the targets formed in accordance with aspects of the present invention (for instance, the average crystalline grain size can be less than or equal to about 150 microns in some aspects of the invention). Small grain sizes and high density can lead to improved sputtering characteristics relative to targets having higher grain sizes and/or lower density, as is known to persons of ordinary skill in the art.

The composition of the can utilized in various aspects of the invention can be any suitable composition. In some aspects it can be desired to have the inner cup of the can be of a different composition than the outer cup of the can so that the inner cup can be more readily removed from a target, while the outer cup will remain tightly bonded to the target. FIG. 27 illustrates an exemplary can 300 comprising an inner cup 304 having a different composition than an outer cup 302.

Although the can compositions discussed in the embodiments above utilize cups containing a homogeneous single composition, it is to be understood that the cups can comprise multiple layers. The utilization of multiple layers can be advantageous in providing good adhesion to a target material or, alternatively, can be advantageous in enhancing the release of the cup from the target material.

FIG. 28 illustrates a can 400 having a outer cup 402 which comprises a first layer 401 and a second layer 403; and having an inner cup 404 which comprises a first layer 405 and a second layer 407. The layer 403 of the outer cup 402 can, in some aspects, enhance adhesion of the outer cup to a target to enhance bonding of the outer cup to the target in forming a target/backing plate construction having the outer cup adhered to the target as a backing plate. The layer 407 of the inner cup can, in some aspects, enhance removal of the inner cup from a target, and accordingly can correspond to a release layer. Exemplary release layers are graphite oils.

Compositions 401 and 405 can be substantially the same as one another, or can be different from one another. In some aspects, layers 401 and 405 can be referred to as outermost shells of cups 402 and 404, respectively, and layers 403 and 407 can be referred to as materials between such outermost shells and a target ultimately formed within can 400.

Layers 403 and 407 are shown as being metallic, but it is to be understood that the layers can comprise any suitable physical state, and in some aspects will be amorphous, powdery, etc. In particular aspects, at least one of the layers can comprise one or more ceramic materials.

FIG. 29 shows a target/backing plate construction 430 formed utilizing the can 400 of FIG. 28. Specifically, such target/backing plate construction comprises the outer cup 402 containing layers 401 and 403 as a backing plate, and comprises a target construction 450 which can be formed from powders consolidated within the can 400 in an appropriate HIPping process. Such HIPping process can utilize methodology analogous to that discussed above with reference to the processing of FIG. 14 or the processing of FIG. 20. The target/backing plate construction 430 can be considered to comprise a backing plate having an outermost shell 401 bonded to a target 450 through an intervening material 403. In particular aspects, target 450 can comprise, consist essentially of, or consist of ruthenium, shell 401 can comprise, consist essentially of, or consist of aluminum, titanium and/or copper, and intervening material 403 can comprise any suitable material for enhancing a bond between the backing plate and the target.

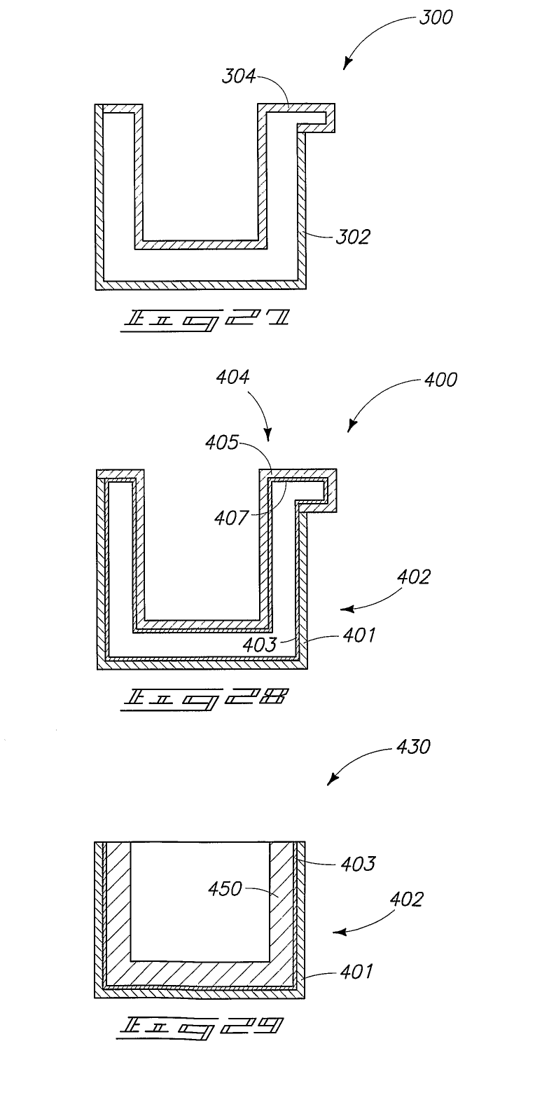

The methods discussed above are exemplary methods of the present invention, and it is to be understood that the invention can also include variations of the above-discussed processing. For instance, in some aspects three-dimensional targets can be formed utilizing vacuum hot pressing of one or more of the above-described powdered materials onto a backing plate having a shape complementary to a desired three-dimensional target (an exemplary backing plate could have the shape of cup 202 of FIG. 26, with or without the flanges 21 1; and the backing plate can comprise any suitable material, including, for example, a material consisting of one or more of aluminum, copper and titanium). Alternatively, a powder can be vacuum hot-pressed, and subsequently subjected to HiPping densification during fabrication of a three-dimensional target.

The invention claimed is:

1. A method of forming a three-dimensional physical vapor deposition target, comprising:
forming a can substantially complementary to a desired three-dimensional shape of the target;
placing powdered material within the can;
subjecting the canned powder to hot isostatic pressing to form the material substantially into a physical vapor deposition target substantially having the desired three-dimensional shape; and
removing only a portion of the can from the physical vapor deposition target.

2. The method of claim 1 further comprising vacuum hot pressing of the powdered material prior to the hot isostatic pressing.

3. The method of claim 1 wherein the material comprises one or more of iridium, cobalt, ruthenium, tantalum, tungsten, chromium and molybdenum.

4. The method of claim 1 wherein the material consists essentially of one or more of iridium, cobalt, ruthenium, tantalum, tungsten, chromium and molybdenum.

5. The method of claim 1 wherein the material consists of one or more of iridium, cobalt, ruthenium, tantalum, tungsten, chromium and molybdenum.

6. The method of claim 5 wherein the can comprises at least one of aluminum, titanium and copper.

7. The method of claim 1 wherein the material consists essentially of ruthenium.

8. The method of claim 1 wherein the desired three-dimensional shape is a hollow cathode magnetron target shape.

9. The method of claim 8 wherein the removal of only some of the can leaves a portion of the can remaining against the physical vapor deposition target as a backing plate.

10. The method of claim 9 wherein the removed part of the can comprises a different composition than the portion of the can remaining against the physical vapor deposition target as the backing plate.

11. The method of claim 9 wherein the remaining portion of the can comprises titanium, and wherein the physical vapor deposition target comprises ruthenium.

12. The method of claim 8 further comprising attaching a flange to the portion of the can remaining as the backing plate.

13. The method of claim 12 wherein an entirety of the flange is attached after the hot isostatic pressing.

14. The method of claim 12 wherein the flange is attached prior to the hot isostatic pressing.

15. The method of claim 12 wherein:
the flange is attached to the portion of the can with a weld prior to the hot isostatic pressing;
an opening is provided through the welded flange, the inside of the flange is substantially evacuated through the opening, and the opening is then sealed prior to the hot isostatic pressing; and
wherein the hot isostatic pressing is utilized to improve the bonding of the flange to the portion of the can.

16. A method of forming a hollow cathode magnetron target, comprising:
forming a can substantially complementary to a desired hollow cathode magnetron target shape;
placing powdered material within the can, the powdered material comprising one or more of iridium, cobalt, ruthenium, tungsten, molybdenum, titanium, aluminum and tantalum;
subjecting the canned powder to hot isostatic pressing to form the material substantially into a physical vapor deposition target substantially having the desired hollow cathode magnetron target shape; and
removing a first portion of the can from the physical vapor deposition target while leaving a second portion of the can as a backing plate attached to the physical vapor deposition target.

17. The method of claim 16 further comprising vacuum hot pressing of the powdered material prior to the hot isostatic pressing.

18. The method of claim 16 wherein an entirety of the powdered material within the can during the hot isostatic pressing consists essentially of ruthenium.

19. The method of claim 16 wherein an entirety of the powdered material within the can during the hot isostatic pressing consists essentially of tungsten.

20. The method of claim 16 wherein an entirety of the powdered material within the can during the hot isostatic pressing consists essentially of molybdenum.

21. The method of claim 16 wherein an entirety of the powdered material within the can during the hot isostatic pressing consists essentially of tantalum.

22. The method of claim 16 wherein an entirety of the powdered material within the can during the hot isostatic pressing consists essentially of tungsten and titanium.

23. The method of claim 16 wherein an entirety of the powdered material within the can during the hot isostatic pressing consists essentially of tungsten and aluminum.

24. The method of claim 16 wherein an entirety of the powdered material within the can during the hot isostatic pressing consists essentially of tantalum and aluminum.

25. The method of claim 16 wherein the first and second portions of the can have substantially the same chemical composition as one another.

26. The method of claim 16 wherein the first and second portions of the can do not have substantially the same chemical composition as one another.

27. The method of claim 16 wherein:
the target consists essentially of a first material;
the second portion of the can comprises an outermost shell consisting essentially of a second material; and
further comprising providing a third material between the outermost shell of the can and the powder prior to the hot isostatic pressing to enhance bonding between the outermost shell and the target.

28. The method of claim 27 wherein the first material is ruthenium and the second material is titanium.

29. The method of claim 16 wherein:
the target consists essentially of a first material;
the first portion of the can comprises an outermost shell consisting essentially of a second material; and
further comprising providing a third material between the outermost shell of the can and the powder prior to the hot isostatic pressing to reduce bonding between the outermost shell and the target.

30. The method of claim 29 wherein the first material is ruthenium and the second material is titanium.

31. The method of claim 29 wherein the third material is a ceramic material.

32. (canceled)

33. (canceled)

34. A three-dimensional physical vapor deposition target comprising a composition containing one or more of iridium, ruthenium, and chalcogenide.

35. The target of claim 34 wherein at least one of the iridium and ruthenium is present as a component of an alloy.

36. The target of claim 34 having a density of at least 98% of a theoretical maximum density of the composition of the target.

37. The target of claim 34 wherein composition is crystalline and has an average crystalline grain size of less than or equal to 150 microns.

38. The target of claim 34 being a hollow cathode magnetron target.

39. The target of claim 34 comprising ruthenium.

40. The target of claim 34 consisting essentially of ruthenium.

41. The target of claim 34 consisting essentially of ruthenium and being bonded to a backing plate consisting essentially-of aluminum, titanium or copper.

42. The target of claim 41 being a hollow cathode magnetron target.

43. The target of claim 34 consisting of ruthenium.
